(19) United States
(12) Patent Application Publication
(10) Pub. No.: US 2023/0009507 A1
(43) Pub. Date: Jan. 12, 2023

(54) A SYSTEM AND METHOD FOR CONTROLLING FIRE IN A BUILDING

(71) Applicant: Joshua Chapman, Greater London (GB)

(72) Inventor: Joshua Chapman, Greater London (GB)

(21) Appl. No.: 17/782,747

(22) PCT Filed: Dec. 4, 2020
(86) PCT No.: PCT/EP2020/084775

§ 371 Date: Jun. 6, 2022

(30) Foreign Application Priority Data
Dec. 6, 2019 (GB) 1917924.1

(51) Int. Cl. A62C 35/68

(52) U.S. Cl. CPC A62C 35/68

(57) ABSTRACT

A system and method for controlling, suppressing, or extinguishing fire in a building. The system includes a distribution channel and at least one deployment mechanism. The distribution channel includes at least one riser fitted or for fitting so as to be located externally to at least one exterior wall of the said building, and the distribution channel is configured to deliver a fire controlling agent to the at least one deployment mechanism, in the case of a fire in the building.

### CROSS-REFERENCE TO RELATED APPLICATIONS

This application is a 35 U.S.C. § 371 national stage application of PCT/EP2020/084775 filed Dec. 4, 2020, and entitled “A System and Method for Controlling Fire in a Building” which claims priority to United Kingdom patent application No. GB1917924.1 filed Dec. 6, 2019, both of which are hereby incorporated herein by reference in their entirety.

### FIELD OF THE DESCRIPTION

The present description relates to a system and method for controlling fire in a building. In embodiments, the description relates to firefighting and a safety system for suppressing and extinguishing fire, and inhibiting the spread of fire in a building.

### BACKGROUND

Fire safety systems are very important features of buildings. This is especially the case for high-rise buildings and apartment blocks. Recent examples of fires in such blocks have demonstrated the dangers that can be presented to inhabitants when a fire takes hold in such a building. One such example is the fire in June 2017 in Grenfell Tower in London, in which many people died as a result of the fire that destroyed much of the building.

Fire is particularly dangerous in high-rise buildings as once it takes over a floor it can make exiting the building dangerous and unsafe for the inhabitants or workers on the upper levels. Further to this, in high-rise buildings there are generally a number of routes fire can take to completely engulf a whole floor or spread between floors. This means that once a fire starts anywhere in such a building the risks to the building as a whole are high.

The vertical nature of high-rise buildings enables fire to spread quickly between floors. Any open or compromised window of a lower floor enables fire to billow out and spread fire to the above floor. In certain instances high-rise buildings have a separate rainscreen cladding, decorative or otherwise, external to the main exterior wall of the building. Such a cladding was present on Grenfell Tower referred to above. In buildings where there is such cladding, or the like, there is often a cavity between the exterior wall of the building and the external cladding. This cavity provides a further avenue for fire to pass between floors and spread throughout the building.

Any cavity, such as one between the exterior wall and external cladding, provides a clear unimpeded route for fire to spread up the side of a building. It may also provide fuel for the fire, depending on the properties of the material within the cavity, and oxygen if there is a draft within the cavity. The chimney effect of such a gap between the exterior wall of a building and the cladding can encourage the spread of the fire by drawing flames up through the gap.

As well as this, external cladding may also diminish the effect of fire firefighting strategies enacted by fire services separate from the building. This depends on the properties of the external cladding. However, if say a fire is started behind the cladding, then to get water or other extinguishing or suppressing agent to it, the fire fighters would need to ensure that the cladding did not cause an obstruction.

One solution currently used to combat the spread of fire within a cavity of a building is to construct or clad the building in fire resistant material, and/or block off sections of a cavity with fire resistant material. For example, as intumescent material can be used that expands upon exposure to fire or heat and can, once expanded form a physical barrier to progression of flames.

Fire resistant material does provide some benefit, but it only inhibits the spread of fire for a limited period of time and will not extinguish it entirely.

### SUMMARY

According to a first aspect of the present description, there is provided a system for controlling fire in a building, the system comprising; a distribution channel; at least one deployment mechanism; wherein the distribution channel comprises at least one riser fitted or for fitting so as to be located externally to at least one exterior wall of the said building; and wherein the distribution channel is configured to deliver a fire controlling agent to the at least one deployment mechanism, in the case of a fire in the building.

A system is provided that enables fire in a building to be controlled. Such control could include one or more of suppression or extinguishing of the fire. In general control of a fire means extinguishing it or stopping or slowing its spreading. The fire could be actually within a room or cavity within the building or alternatively could be in the space immediately surrounding the building, i.e. involving an external wall or cladding of the building. Such a fire would still be in the building.

In an embodiment, at least one of the exterior walls of the building has external cladding, the distribution channel is located or for locating within the cavity between the exterior wall and the external cladding.

In an embodiment, at least one of the exterior walls of the building has external cladding, the distribution channel is located or for locating externally to both the exterior wall and external cladding.

In an embodiment, at least one of the exterior walls of the building has external cladding, the distribution channel is located or for locating both within the cavity between the exterior wall and the external cladding, and externally to both the exterior wall and external cladding.

In an embodiment, the at least one deployment mechanism is configured to disperse the extinguishing agent within the cavity between the exterior wall and the external cladding.

In an embodiment, the at least one deployment mechanism is configured to disperse the extinguishing agent externally to any external cladding.

In an embodiment, the at least one deployment mechanism is configured to disperse the extinguishing agent within the cavity between the exterior wall and the external cladding and externally to any external cladding.

In an embodiment, the at least one deployment mechanism is a sprinkler.

In an embodiment, the fire controlling agent is water.

In an embodiment, the fire controlling agent is a stored in an external reservoir connectable to the distribution channel.

In an embodiment, the distribution channel is empty of any fire controlling agent.

In an embodiment, the distribution channel is used to store fire controlling agent.

In an embodiment, the extinguishing agent is only distributed to the at least one deployment mechanism upon a demand for the extinguishing agent for combating a fire in a building.

In an embodiment, the at least one riser, or the working channel, is fitted or for fitting vertically, or vertically in parallel, on the side of the at least one exterior wall of the said building.

In an embodiment, there is at least one distribution pipe configured to direct the flow of a fire control agent from the at least one riser to the at least one deployment mechanism.

In an embodiment, the at least one distribution pipe is fitted or for fitting horizontally, or horizontally in parallel, on the side of the at least one exterior wall of the said building.

In an embodiment, the reservoir is fitted or for fitting on the roof of the said building and is configured to deliver the fire controlling agent to the distribution channel.

In an embodiment, there is a release mechanism configured to deliver the fire control agent into the distribution channel from the reservoir in the situation that there is demand for fire control agent.

In an embodiment, the release mechanism is a release valve linked to the fire detection and alarm system of the said building; wherein when the fire detection or alarm system sends the appropriate signal the release valve opens, providing a path for the fire control agent to enter the distribution channel from the reservoir.

In an embodiment, there is at least one deployment valve, that when open allows for the fire controlling agent to be distributed by the at least one deployment mechanism.

In an embodiment, there is at least one riser valve that when open allows for the fire controlling agent to pass from the reservoir to the at least one riser of the distribution channel.

In an embodiment, the at least one deployment valve and at least one riser valve are remotely controlled.

In an embodiment, the heat and/or fire detection or alarm system of the building remotely controls the at least one deployment valve and at least one riser valve; wherein the at least one deployment valve and at least one riser valve are controlled such that fire controlling agent is distributed to the local area of the building the fire is within.

In an embodiment, a transmitter remotely controls the at least one deployment valve and/or at least one riser valve; wherein the at least one deployment valve and at least one riser valve are controlled such that fire controlling agent is distributed to the local area of the building the fire is within.

According to a second aspect of the present description, there is provided a method of improving fire safety in a building comprising fitting a system for controlling or suppressing fire in a building, wherein the system comprises; a distribution channel; at least one deployment mechanism; wherein the distribution channel comprises at least one riser to be fitted externally to at least one exterior wall of the said building; and wherein the distribution channel is configured to deliver a fire controlling agent to the at least one deployment mechanism, in the case of a fire in the building.

In an embodiment of the method, the system is a system according to the first aspect of the present description optionally including any one or more of the features presented above as being provided in an embodiment.

Thus, a system is provided that can not only inhibit the spread of fire in high-rise buildings but can also function to suppress and even extinguish fire in a cavity of a high-rise building. This is particularly the case in a cavity formed between the exterior wall and external cladding.

In embodiments, the present description provides a system for combating fire in the cavity of a building. In a non-limiting embodiment, the system is a system of water (or other fire extinguishing, retarding or suppressing medium) distributing pipes that direct the fire extinguishing, retarding or suppressing medium such as water to a deployment mechanism such as a sprinkler. Preferably, the sprinkler is situated externally to an external cladding of a building, and/or within a cavity, between the exterior wall and external cladding, of a building.

A major benefit of this system is that it aids in supressing and/or inhibiting fire and its movement throughout a building.

The system can be easily included when building new high-rise buildings, and the like, but importantly can also be retrofitted to existing high-rise buildings with ease.

### BRIEF DESCRIPTION OF THE DRAWINGS

Embodiments of the present description will now be described in detail with reference to the accompanying drawings, in which:

FIG. 1 is a schematic drawing of the present system installed onto the wall of a building and fed a fire control agent by a reservoir on the roof of said building.

FIG. 2 is a schematic of a portion of the system installed in the cavity of a building, the cavity being between the exterior wall and external cladding of a building.

FIG. 3 is a plan view of the schematic of FIG. 2.

FIG. 4 is a side on view of the schematic of FIG. 2.

FIG. 5 is a schematic of a portion of the system installed externally to any cladding of the building and in the cavity of a building, the cavity being between the exterior wall and external cladding of a building.

FIG. 6 is a plan view of the schematic of FIG. 5.

FIG. 7 is a side on view of the schematic of FIG. 5.

FIG. 8 is a schematic of a portion of the system installed externally to the external cladding of a building.

FIG. 9 is a plan view of the schematic of FIG. 8.

FIG. 10 is a side on view of the schematic of FIG. 8.

### DETAILED DESCRIPTION

There is disclosed herein a system of one or more interconnected sprinklers for distributing a fire-controlling agent, such as but not limited to water, to control a fire in a building. Specifically, this serves to control and extinguish fire that has spread into the cavity formed between the exterior wall and external cladding of a building.

Mention of fire in, of or on a building, in the present application, means a fire that is associated with a building whether it started inside the building or not and specifically whether the fire is actually inside the exterior wall of a building or not. The word building relates to any material or component that forms part of the building, whether internal or external.

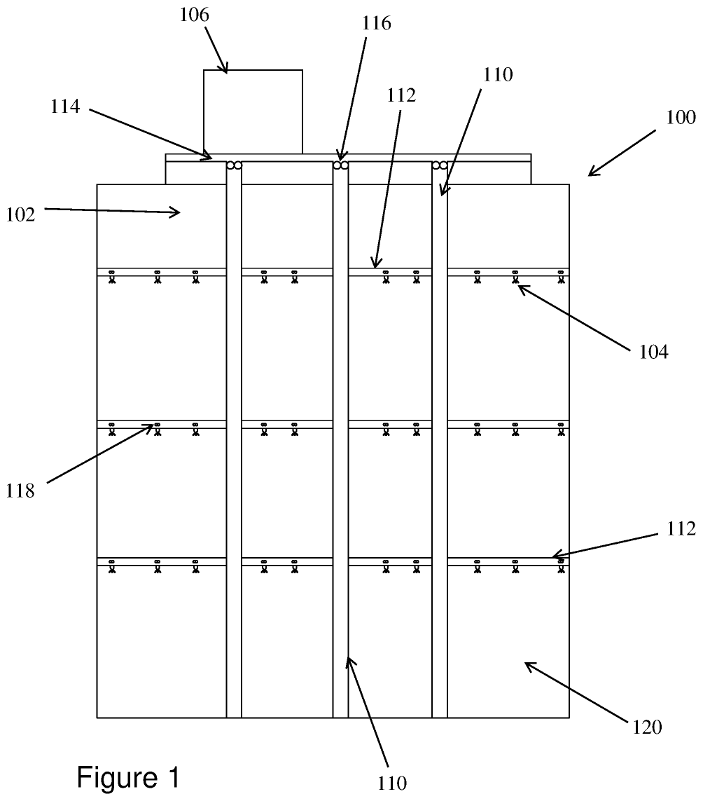

FIG. 1 is an embodiment of a system 100 for one or more of suppressing, controlling or extinguishing fire in a building, hereinafter simply referred to as a system for controlling fire in a building. The system 100 comprises a distribution channel 102, one or more deployment mechanisms 104 and a reservoir 106 containing a fire controlling, supressing or extinguishing agent (hereinafter simply referred to as a fire controlling agent). In this example, the distribution channel 102 is comprised of a system of risers 110 and distribution pipes 112. Typically, the diameter of the risers 110 may be between 5 cm and 20 cm. Preferably the diameter is between 8 and 12 cm and more preferably is 10 cm. The distribution pipes 112 will typically have smaller diameters, e.g. between 3 and 6 cm, or preferably 5 cm, than that of the riser. The diameter of both the risers and the distribution pipes are selected so as to ensure that sufficient volume of fire suppressing, controlling or extinguishing agent can be delivered to a particular part of the building.

In this embodiment reservoir 106 is connected to the upper ends of the risers 110 by a connecting pipe 114. Flow of the fire controlling agent from the reservoir 106 to the distribution channel 102 is controlled by valves 116. The reservoir 106 in this example is provided on the roof of the building but in other examples the reservoir could be located in different locations. For example if the building has a service room or empty roof space above or between floors, the reservoir could be positioned in this location. In addition in some buildings if the number of floors is high it is possible that plural reservoirs could be provided, say every 5, 10 or 20 floors.

Risers 110 are connected to one or more distribution pipes 112 which branch off from the risers. In the example shown a plurality of distribution pipes 112 are provided that are arranged as generally horizontal pipes in parallel down the sides of the building. The distribution pipes 112 have on them a plurality of deployment mechanisms 104. Deployment valves 118 control the flow of fire controlling agent through the deployment mechanisms 104.

FIG. 1 shows the risers as being vertically distributed on the side of a building in parallel, this is not a limiting feature. The risers 110 can be in any configuration with respect to the side of a building. Any angle to the vertical would work. So long as there is sufficient pressure of the fire controlling agent within the risers 110, they may be distributed up the side of the external wall of a building in any orientation. This is also true of the distribution pipes 112 which branch off from the riser(s) 110 horizontally in FIG. 1. The distribution pipes 112 can be configured in any orientation with respect to the risers 110 and the exterior wall of the building.

In FIG. 1, the location of the reservoir on the roof of the building means that gravity ensures that there is sufficient pressure in the risers 110 and distribution pipes 112 for delivering the fire controlling agent to the deployment mechanisms 104. However, pressure of the fire controlling agent can be increased by other means, such as a pump, mechanical or otherwise. One or more pumps can be provided in close proximity to the reservoir(s) or alternatively positioned at various points along the riser(s) or distribution pipe(s).

In general the embodiment of FIG. 1 is connected up to the internal fire detection and alarm systems of the building in which it is installed. The fire detection and alarm systems are connected to the valves 116 and deployment valves 118 which, when activated by the fire detection and/or alarm system, open up to enable the distribution of the fire controlling agent to extinguish and combat the spread of fire in the building. A heat and/or fire operated activation mechanism may be used for the triggering of the fire controlling system.

The connection between the fire/heat detection and alarm system and the system 100 for suppressing fire in a building enables the fire controlling agent to be directionally directed to combat a fire in a specific portion of the building by only opening the valves 116 and deployment valves 118 in the area of the building that the fire is affecting. This directionality of the system 100 allows for the effort of fire controlling agent to be more effective at suppressing and extinguishing a fire at its source. Should the fire spread to another, different, area the heat/fire detection and alarm system is able to open further valves 116 and deployment valves 118 to direct fire controlling agent to the new area. It is also possible to remotely control the valves 116 and distribution valves 118 by some external device, such as but not limited to a radio transmitter, which provides system 100 with information detailing which valves 116 and distribution valves 118 to open in order to suppress fire in specific areas of the building.

The risers 110 and distribution pipes 112 can be of any shape, size or cross-section so long as any fire controlling agent is able to pass through the risers 110 and distribution pipes 112 in order to combat fire in a building. In the embodiment of FIG. 1 the risers 110 are cylindrical pipes that are 4 inches in diameter, distribution pipes 112 are cylindrical pipes of 2 inch diameter. Preferably both the risers 110 and distribution pipes 112 are made of steel, coated so as to be resistant to rusting. It will be appreciated that the shape, size and cross-sections of any pipes, and the material they are made from, will depend on factors such as the dimensions of the building they are being fitted to and flow rate necessary to distribute a suitable amount of fire controlling agent to suppress and/or extinguish a fire in a building, and the type of fire controlling agent used in the system 100.

The deployment mechanisms 104 of system 100 are preferably sprinklers, but it will be appreciated that any form of distribution device will be able to achieve the desired distribution of the fire controlling agent, such as, but not limited to a sprinkler, a faucet, a spigot, a valve, an opening in the pipe, or the like.

Preferably the fire controlling agent is water. However, it will be appreciated that the fire controlling agent can be any number of things that are currently used to supress fire such as, but not limited to, water and foam, carbon dioxide, dry chemical, wet chemical, clean agent, dry powder, water mist, or the like.

The system 100 for suppressing fire can either be a wet system, in which there is continually fire controlling agent within the risers 110 and distribution pipes 112 of distribution channel 102, or it can be a dry system, in which there is no fire controlling agent in the risers 110 and distribution pipes 112 of distribution channel 102. The advantage of a dry system is that the risk of the freezing of pipes when the ambient temperature is low is avoided. If a wet system is used then some heating mechanism can be provided.

Indeed, the system 100 may be specifically designed to allow both dry-pipe and wet-pipe sprinkler systems to be installed externally between an external rainscreen cladding system and an internal primary wall structure, i.e. the external wall of a building

In embodiments, the system 100 for suppressing fire incorporates main risers leading from a rooftop/plantroom reservoir and passing vertically down to all floors. At each floor level there is a branching out horizontally and the inclusion of heat-activated sprinkler heads at designated locations around the perimeter of the building. Main risers will pass through a slab level fire stopping and preferably therefore include intumescent sealing at each fire break level.

Should a wet-pipe method of installation be used, the pipes (both vertical risers and horizontal branches) are preferably provided with insulation and/or possible trace heating to prevent freezing and thus maintain operational effectiveness during particularly inclement weather conditions. Should the dry-pipe method of installation be chosen the reservoir is maintained at above freezing levels to maintain operational effectiveness during particularly inclement weather conditions

The external cladding and access systems are designed to allow for periodic testing and maintenance of the system 100.

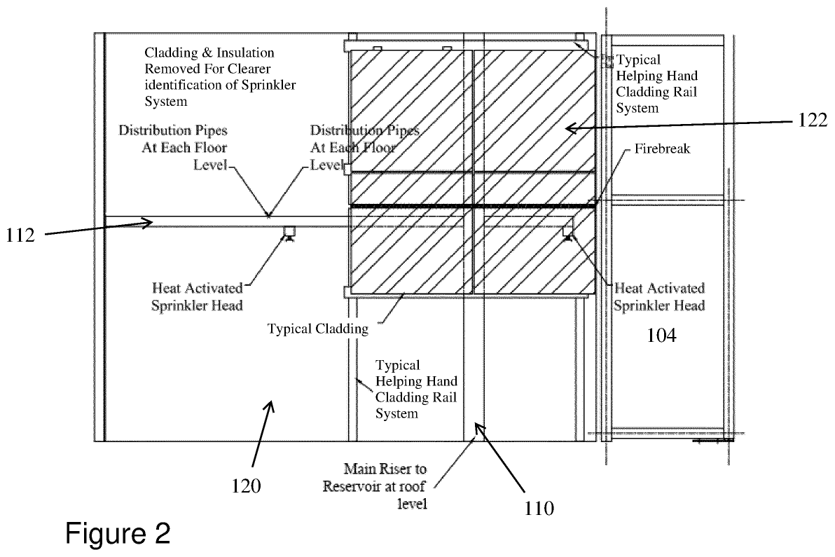

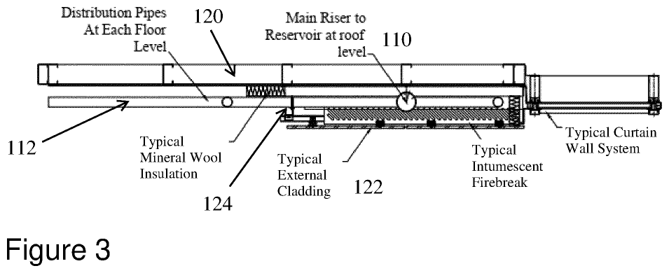

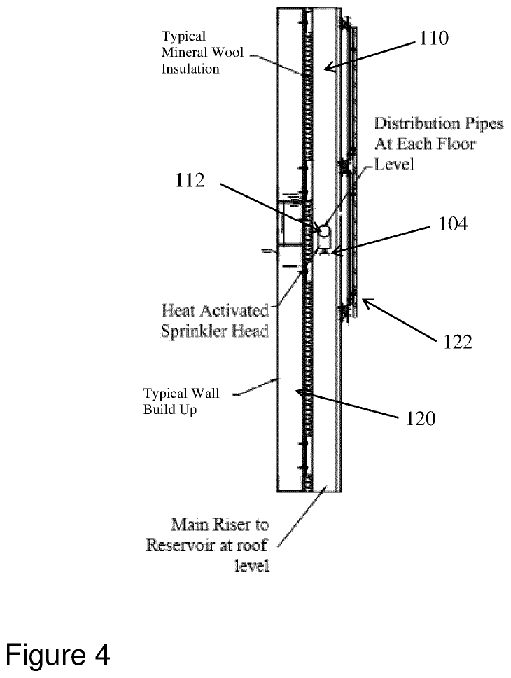

FIGS. 2, 3 and 4 show close up schematics, from various viewpoints, as to how the system 100 for suppressing fire can be installed between the exterior wall 120 and external cladding 122 of a building. In this embodiment both the riser 110 and the distribution pipes 112 are fixed onto the exterior wall 120 of the building underneath the external cladding 122. The precise structure of the external wall 120 is not of primary importance, but in the example shown it can be seen to be made up of various bricks, blocks or panels and a layer of mineral wool insulation. In this embodiment sprinklers are provided as the deployment mechanisms 104. They are positioned in series along the distribution pipe, again in the cavity 124 between the exterior wall 120 and cladding 122.

The cladding 122 includes a layer of intumescent material on its surface which can serve to act as a fire break between floors of the building in the event of a fire. However due to the nature of the riser 110 and its connection to the reservoir, any expansion of the intumescent layer will not affect directly the operation of the system 100.

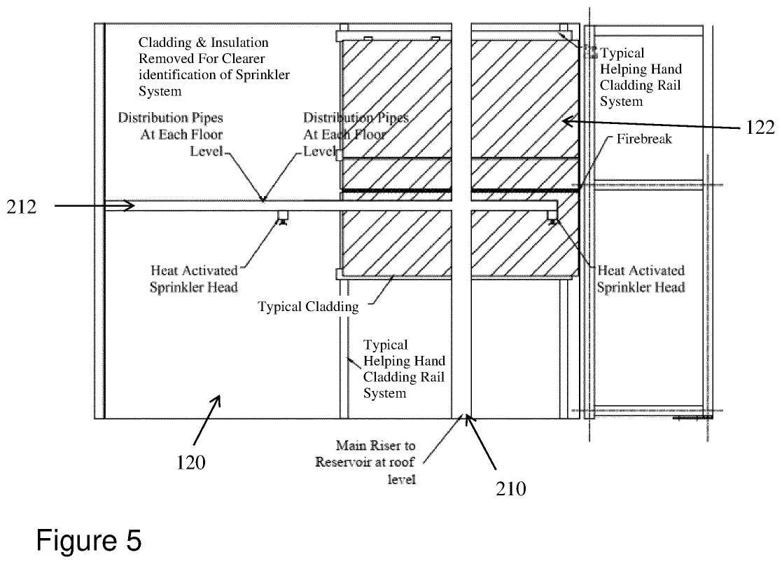

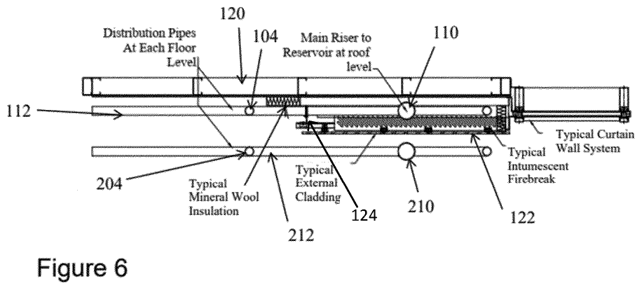

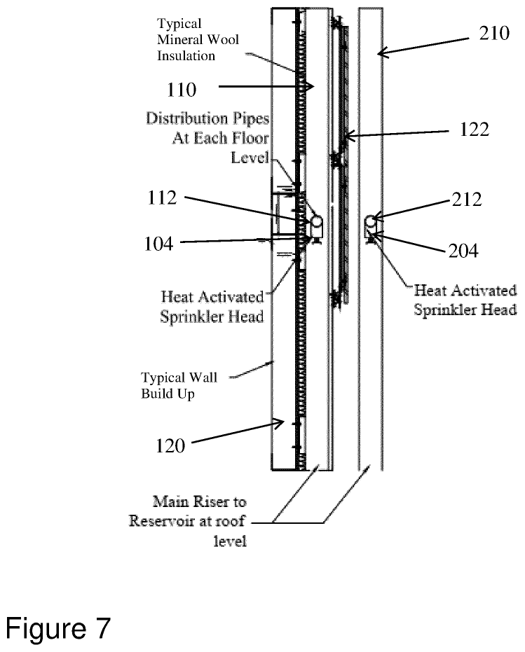

FIGS. 5, 6 and 7 show close up schematics, from various viewpoints, of an alternate embodiment of the present description. As in the previous embodiment there is attached in cavity 124, between exterior wall 120 and cladding 122, features of system 100. However, this embodiment has a further system 200 attached externally to cladding 122. System 200 has analogous features to system 100. In this embodiment all the feature of system 200 are all external to the cladding 122.

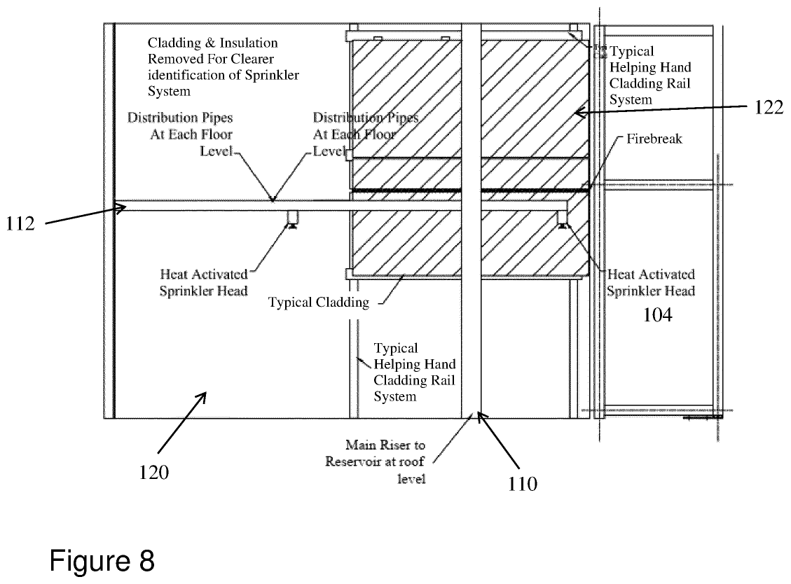

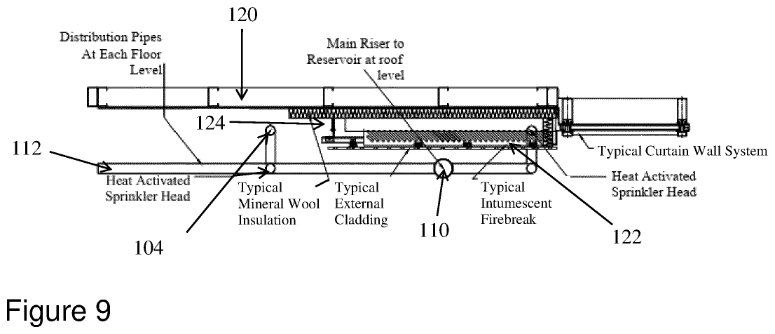

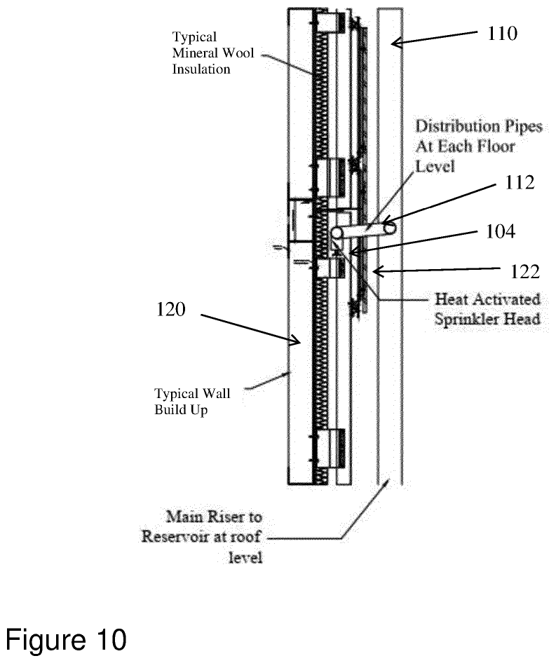

FIGS. 8, 9 and 10 show close up schematics, from various viewpoints, of an alternative embodiment of the present description. In this embodiment the system 100 is external to the external cladding 122, except for distribution pipes 112 which, as well as branching off from riser 110 horizontally, enter horizontally into cavity 124 between exterior wall 120 and cladding 122. In this embodiment the deployment mechanisms 104 are located both inside the cavity 124 and externally to the external cladding 122. One particular advantage of this embodiment is the ability easily to fit it to an existing building. In other words it can be easily retro-fit to a building.

In the event of system 100 being detecting or be notified of a fire in the building, by the heat/fire detection or alarm system of the building or any other means, system 100 is instructed by the aforementioned system, or means, as to the location of the fire. The necessary valves 116 and deployment valves 118 are opened such that there is an open channel through the distribution channel 102 for the fire controlling agent to pass through to the relevant deployment mechanisms 104. The deployment mechanisms 104 are then able to deploy the fire controlling agent to the areas of the building, and specifically to the areas in the cavity 124 and surrounding cladding 122, that the fire is located within, to supress the fire.

Embodiments of the present description have been described with particular reference to the examples illustrated. However, it will be appreciated that variations and modifications may be made to the examples described within the scope of the present description.

1. A system for controlling fire in a building, the system comprising;
a distribution channel; and
at least one deployment mechanism;
wherein the distribution channel comprises at least one riser fitted or for fitting so as to be located externally to at least one exterior wall of the said building; and
wherein the distribution channel is configured to deliver a fire controlling agent to the at least one deployment mechanism, in the case of a fire in the building.

2. The system of claim 1, wherein at least one of the exterior walls of the building has external cladding, and wherein the distribution channel is located or for locating within the cavity between the exterior wall and the external cladding.

3. The system claim 1, wherein at least one of the exterior walls of the building has external cladding, and wherein the distribution channel is located or for locating externally to both the exterior wall and external cladding.

4. The system of claim 1, wherein at least one of the exterior walls of the building has external cladding, wherein the distribution channel is located or for locating both within the cavity between the exterior wall and the external cladding, and externally to both the exterior wall and external cladding.

5. The system of claim 2, wherein the at least one deployment mechanism is configured to disperse the extinguishing agent within the cavity between the exterior wall and the external cladding.

6. The system of claim 2, wherein the at least one deployment mechanism is configured to disperse the extinguishing agent externally to any external cladding.

7. The system of claim 2, wherein the at least one deployment mechanism is configured to disperse the extinguishing agent within the cavity between the exterior wall and the external cladding and externally to any external cladding.

8. The system of claim 1, wherein the at least one deployment mechanism is a sprinkler.

9. The system of claim 1, wherein the fire controlling agent is water.

10. The system of claim 1, wherein the fire controlling agent is a stored in an external reservoir connectable to the distribution channel.

11. The system of claim 1, wherein the distribution channel is empty of any fire controlling agent.

12. The system of claim 1, wherein the distribution channel is used to store fire controlling agent.

13. The system of claim 1, wherein the extinguishing agent is only distributed to the at least one deployment mechanism upon a demand for the extinguishing agent for combating a fire in a building.

14. The system of claim 1, wherein the at least one riser, or the working channel, is fitted or for fitting vertically, or vertically in parallel, on the side of the at least one exterior wall of the said building.

15. The system of claim 1, wherein there is at least one distribution pipe configured to direct the flow of a fire control agent from the at least one riser to the at least one deployment mechanism.

16. The system of claim 15, wherein the at least one distribution pipe is fitted or for fitting horizontally, or horizontally in parallel, on the side of the at least one exterior wall of the said building.

17. The system of claim 10, wherein the reservoir is fitted or for fitting on the roof of the said building and is configured to deliver the fire controlling agent to the distribution channel.

18. The system of claim 17, wherein there is a release mechanism configured to deliver the fire control agent into the distribution channel from the reservoir in the situation that there is demand for fire control agent.

19. The system of claim 18, wherein the release mechanism is a release valve linked to the fire detection and alarm system of the said building;
wherein when the fire detection or alarm system sends the appropriate signal the release valve opens, providing a path for the fire control agent to enter the distribution channel from the reservoir.

20. The system of claim 1, wherein there is at least one deployment valve, that when open allows for the fire controlling agent to be distributed by the at least one deployment mechanism.

21. The system of claim 10, wherein there is at least one riser valve that when open allows for the fire controlling agent to pass from the reservoir to the at least one riser of the distribution channel.

22. The system of claim 20, wherein the at least one deployment valve and at least one riser valve are remotely controlled.

23. The system of claim 22, wherein the fire detection or alarm system of the building remotely controls the at least one deployment valve and at least one riser valve; and
wherein the at least one deployment valve and at least one riser valve are controlled such that fire controlling agent is distributed to the local area of the building the fire is within.

24. The system of claim 22, wherein a transmitter remotely controls the at least one deployment valve and at least one riser valve; and
wherein the at least one deployment valve and at least one riser valve are controlled such that fire controlling agent is distributed to the local area of the building the fire is within.

25. A method of improving fire safety in a building, comprising:
fitting a system for controlling fire in a building, wherein the system comprises:
a distribution channel; and
at least one deployment mechanism;
wherein the distribution channel comprises at least one riser to be fitted externally to at least one exterior wall of the said building; and
wherein the distribution channel is configured to deliver a fire controlling agent to the at least one deployment mechanism, in the case of a fire in the building.

26. (canceled)
